(19) United States
(12) Patent Application Publication
(10) Pub. No.: US 2012/0299922 A1
(43) Pub. Date: Nov. 29, 2012

(54) IMAGE PROCESSING APPARATUS AND METHOD

(75) Inventors: In Woo HA, Seoul (KR); Hyun Jung Shim, Seoul (KR); Tobias Ritschel, Saarbrucken (DE); Do Kyoon Kim, Seongnam-si (KR); Tae Hyun Rhee, Yongin-si (KR); Elmar Eisemann, Saarbrucken (DE); Hans-Peter Seidel, Saarbrucken (DE)

(73) Assignee: SAMSUNG ELECTRONICS CO., LTD., Suwon-si (KR)

(21) Appl. No.: 13/182,662

(22) Filed: Jul. 14, 2011

(30) Foreign Application Priority Data
Jul. 14, 2010 (KR) 10-2010-0068140

(51) Int. Cl. G06T 15/06

(52) U.S. Cl. 345/426

(57) ABSTRACT

Provided is an image processing apparatus. The image processing apparatus may adaptively sample a virtual point light (VPL) at a light view within a three-dimensional (3D) model. The image processing apparatus may adaptively sample a surface point at a camera view.

### CROSS-REFERENCE TO RELATED APPLICATIONS

This application claims the priority benefit of Korean Patent Application No. 10-2010-0068140, filed on Jul. 14, 2010, in the Korean Intellectual Property Office, the disclosure of which is incorporated herein by reference.

### BACKGROUND

1. Field

Example embodiments relate to rendering of an object configured as a three-dimensional (3D) model and, more particularly, to a process of sampling a virtual point light (VPL) above the 3D model and sampling a surface point in a real-time 3D rendering process using a radiosity scheme.

2. Description of the Related Art

With development of hardware and software, increasing attentions has been paid to real-time rendering with respect to a three-dimensional (3D) model in a variety of fields, for example, a 3D game, a virtual word animation, a movie, and the like.

An amount of calculations for high quality 3D rendering may increase. In a conventional art, real-time rendering has been constrained due to a low hardware performance. Accordingly, conventional researches have been made to decrease the amount of calculations by effectively performing a calculation while enhancing a hardware performance.

For example, a 3D rendering scheme may include a rendering scheme of enhancing a rendering quality based on an area receiving direct illumination by light present within a 3D model, an indirect illumination occurring due to reflected light of the direct illumination reflected from an object and a scattered reflection, and the like.

In this example, a process of positioning a VPL at a particular position within the 3D model and generating a shadow map from a view of the VPL may be used. However, a relatively large amount of calculations may be used to generate the shadow map. Accordingly, there is a desire for a method and apparatus that may effectively sample a VPL while enhancing a rendering quality, and may also effectively perform surface sampling at a camera view.

### SUMMARY

The foregoing and/or other aspects are achieved by providing an image processing apparatus, including a virtual point light (VPL) sampling unit to sample a plurality of potential VPLs by rendering a three-dimensional (3D) model at a light view, an influence calculator to calculate an influence with respect to at least one surface point sampled at a camera view, with respect to each of the potential VPLs, and a VPL selector to select at least one VPL from the plurality of potential VPLs based on the calculated influence.

The VPL sampling unit may adaptively sample the plurality of potential VPLs based on at least one of a distance from the light view, a bidirectional reflectance of an object point, and a color of the object point.

The VPL sampling unit may adaptively sample the plurality of potential VPLs based on a color value obtained by rendering the 3D model at the light view.

The image processing apparatus may further include a point sampling unit for sampling at least one surface point from geometry information of the 3D model at the camera view.

The point sampling unit may adaptively sample the at least one surface point based on at least one of a distance from the camera view, a bidirectional reflectance of an object point, and a color of the object point.

The image processing apparatus may further include a rendering unit to generate a shadow map with respect to each of the at least one VPL, and to render an image of the 3D model observed at the camera view, using a radiosity scheme.

The influence may be calculated based on at least one of a distance between each of the potential VPLs and the at least one surface point, and an inner product of a normal vector.

The VPL selector may select the at least one VPL from the plurality of potential VPLs by calculating a cumulative distribution function (CDF) of a distribution curve of the influence With respect to each of the potential VPLs, and by randomly selecting a CDF value.

The VPL selector may determine at least one additional VPL around the selected at least one VPL.

The foregoing and/or other aspects are achieved by providing an image processing apparatus, including a point sampling unit to sample at least one surface point from geometry information of a 3D model at a camera view, an influence calculator to calculate an influence with respect to each of at least one surface point, with respect to each of at least one visible point that is visible at a light view, among the at least one surface point, and a VPL selector to select at least one VPL from the at least one visible point based on the calculated influence.

The point sampling unit may adaptively sample the at least one surface point based on at least one of a distance from the camera view, a bidirectional reflectance of an object point, and a color of the object point.

The foregoing and/or other aspects are achieved by providing an image processing method, including sampling a plurality of potential virtual point lights (VPLs) by rendering a three-dimensional (3D) model at a light view, calculating an influence with respect to at least one surface point sampled at a camera view with respect to each of the potential VPLs, and selecting at least one VPL from the plurality of potential VPLs based on the calculated influence.

The example embodiments may include an image processing apparatus and method that may significantly decrease a calculation waste occurring to generate a shadow map with respect to VPLs, which may be unhelpful to an image that is to be rendered at a camera view, and may enhance a rendering processing rate when uniformly or randomly arranging the VPLs at a light view.

The example embodiments may include an image processing apparatus and method that may decrease a calculation waste occurring due to an area not greatly affecting a rendering quality and may enhance a rendering rate when performing surface point sampling with respect to an object at a camera view.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 illustrates an image processing apparatus according to example embodiments;

FIG. 2 illustrates a three-dimensional (3D) model rendered by an image processing apparatus and method according to example embodiments;

FIG. 3 illustrates an object and a light source of the 3D model of FIG. 2;

FIG. 4 illustrates a potential virtual point light (VPL) adaptively sampled at a light view of FIG. 3;

FIG. 5 illustrates a surface point adaptively sampled at a camera view of FIG. 3;

FIG. 6 illustrates an operation of an influence calculator of the image processing apparatus of FIG. 1 according to example embodiments;

FIG. 7 illustrates VPLs selected from potential VPLs of FIG. 4 according to example embodiments;

FIG. 8 illustrates the selected VPLs of FIG. 7 observed at the camera view of FIG. 3;

FIG. 9 illustrates a result of rendering the 3D model of FIG. 2 at the camera view of FIG. 3 based on the VPLs of FIG. 8 according to example embodiments; and

FIG. 10 illustrates an image processing method according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

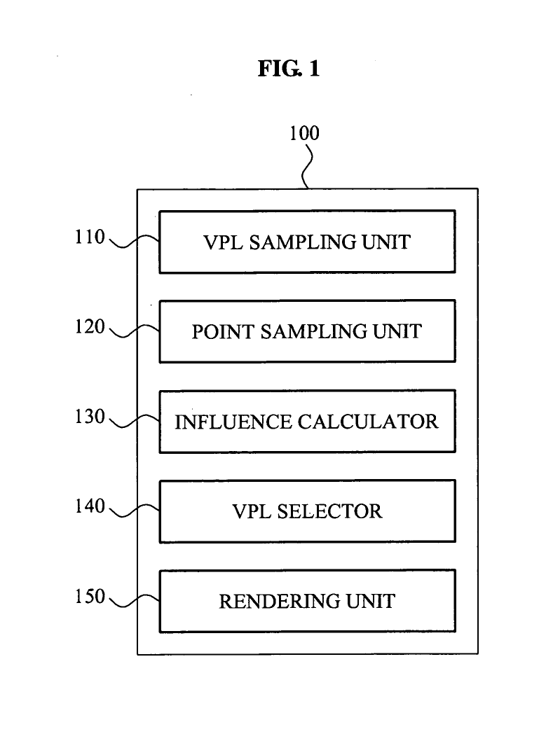

FIG. 1 illustrates an image processing apparatus 100 according to example embodiments.

Referring to FIG. 1, the image processing apparatus 100 may include a virtual point light (VPL) sampling unit 110, a point sampling unit 120, an influence calculator 130, a VPL selector 140, and a rendering unit 150.

The VPL sampling unit 110 may sample a plurality of potential VPLs within a three-dimensional (3D) model based on an object characteristic and a position of a real light view within the 3D model. The plurality of potential VPLs correspond to candidates of a final VPL that is used for a radiosity scheme.

The VPL sampling unit 110 may sample the potential VPLs in a visible area at a light view within the 3D model.

In this example, as a distance from the light view becomes shorter, as a bidirectional reflectance increases, and as an object surface color becomes brighter, the potential VPLs may be further densely sampled.

In the case of a perspective projection when the 3D model is rendered at the light view, as the distance from the light view becomes shorter, the potential VPLs may be densely sampled. As the distance from the light view becomes longer, the potential VPLs may be sparsely sampled.

As a bidirectional reflectance of an object increases based on a bidirectional reflectance distribution function (BRDF), and as a surface color becomes brighter, the potential VPLs may be densely sampled.

When sampling the potential VPLs, the VPL sampling unit 110 may adaptively perform sampling based on the light view, instead of uniformly or randomly sampling the potential VPLs. The above adaptive sampling may concentrate calculation resources on an area substantially affecting the rendering quality and thus, it is possible to enhance the calculation efficiency.

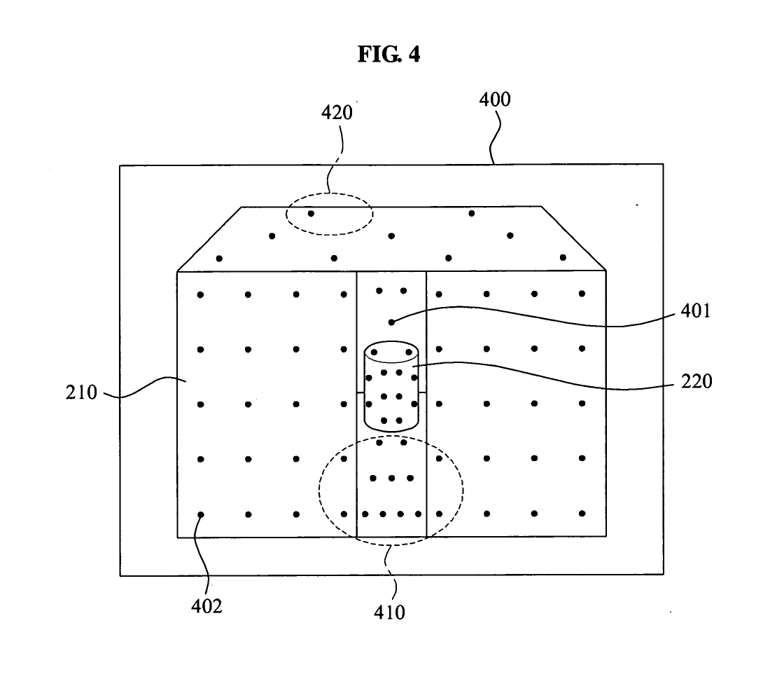

The potential VPL sampling will be further described with reference to FIG. 4.

Depending on embodiments, a process of sampling, by the VPL sampling unit 110, potential VPLs may be omitted. For example, since the 3D model is rendered at the light view, a total of points corresponding to visible pixels may be determined as the potential VPLs without separate sampling.

Hereinafter, even though not particularly described, potential VPL sampling may select, as potential VPLs, a total of visible samples rendered at the light view, without separate sampling.

The point sampling unit 120 may sample a plurality of surface points representing geometry information within a mesh based 3D model, based on the 3D model.

3D rendering of a radiosity scheme using generation of a shadow map and a shadow test may sample and process geometry information of an object based on a point.

In this example, the point sampling unit 120 may adaptively sample surface points to be used for rendering.

Adaptive sampling of the surface points indicate dense sampling of surface points on an area substantially affecting the rendering quality and parse sampling of surface points on an area not affecting the rendering quality.

The point sampling unit 120 may perform adaptive surface point sampling using a variety of example embodiments.

For example, with respect to meshes of a 3D model, the point sampling unit 120 may perform dense point sampling in an area dose to a camera view desired to be rendered, and may perform sparse point sampling as a distance from the camera view becomes greater. In the area close to the camera view, a level of detail (LOD) may need to be increased.

Together with the aforementioned example embodiment, or instead of the aforementioned example embodiment, a plurality of view sample pixels corresponding to visible pixels may be selected by performing rendering in advance at the camera view.

After determining view sample points corresponding to the selected plurality of view sample pixels, surface points may be densely sampled as a distance from the view sample points becomes shorter. Here, the view sample points may correspond to geometry information of each mesh within the 3D model

In either case, even though a calculation amount may be concentrated to increase the LOD in the area greatly affecting the actual rendering quality, a detailed method may be different depending on embodiments.

In addition to the aforementioned example embodiments, as far as adaptively performing dense surface point sampling in the area affecting the rendering quality, surface point sampling may be performed using other example embodiments.

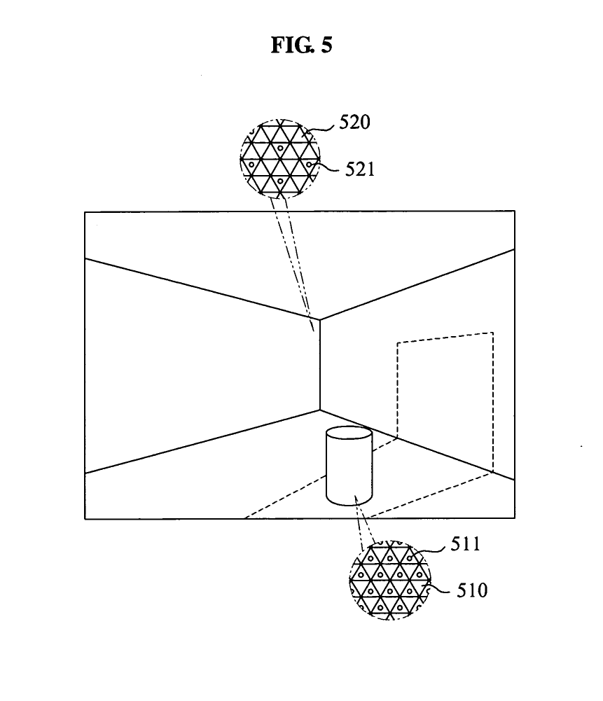

An operation of the point sampling unit 120 will be further described with reference to FIG. 5.

The influence calculator 130 may calculate an influence with respect to surface points sampled by the point sampling unit 120, with respect to each of potential VPLs.

All the potential VPLs that are VPL candidates for rendering may not affect the rendering quality. Some potential VPLs may not affect any of visible point samples at a camera view, or may give only a slightest affect. Accordingly, corresponding potential VPLs may be excluded.

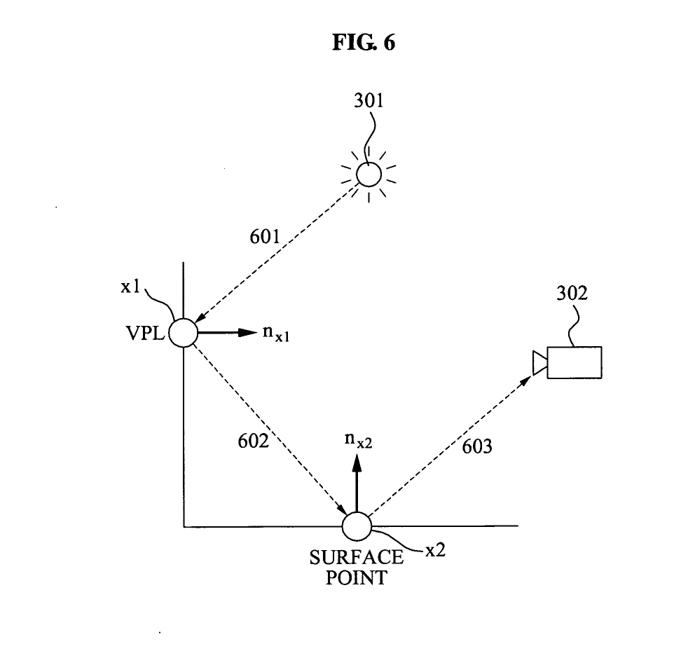

An operation of the influence calculator 130 will be further described with reference to FIG. 6.

The VPL selector 140 may select, as a final VPL to be used for 3D rendering of a radiosity scheme, only a potential VPL having an influence greater than or equal to a predetermined threshold.

In addition to selecting of a portion of the potential VPLs, the VPL selector 140 may sample additional VPLs around a selected VPL by using the selected VPL as a seed. The above process may be referred to as super sampling of additional VPLs.

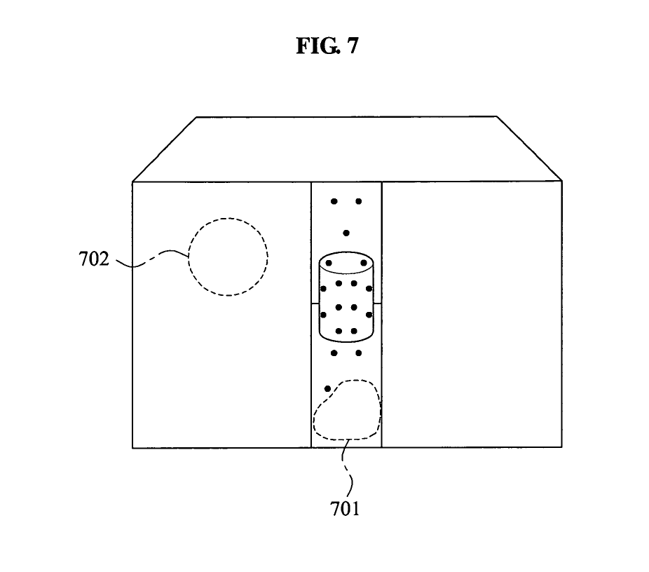

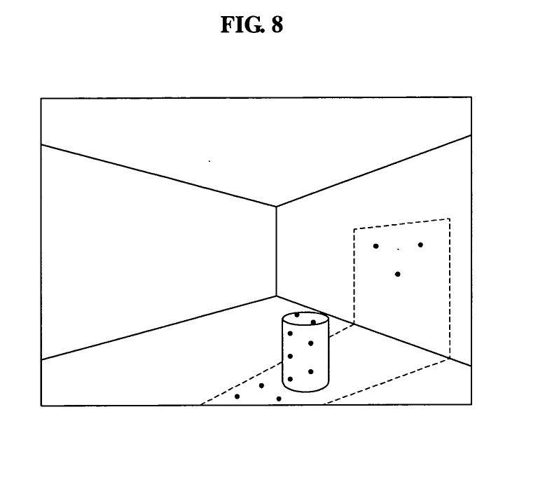

The VPL selection process and result will be further described with reference to FIG. 7 and FIG. 8.

The rendering unit 150 may sample the 3D model using selected VPLs according to a global illumination based radiosity scheme and the like. In the above process, the rendering unit 150 may generate a shadow map with respect to each of the selected VPLs and perform a shadow test with respect to visible points at a camera view.

According to the example embodiments, VPLs may be sparsely arranged in an area not affecting the rendering quality, and VPLs may be densely arranged in an area greatly affecting the rendering quality. Accordingly, the efficiency for the shadow map generation and the shadow test calculation of the rendering unit 150 may significantly increase.

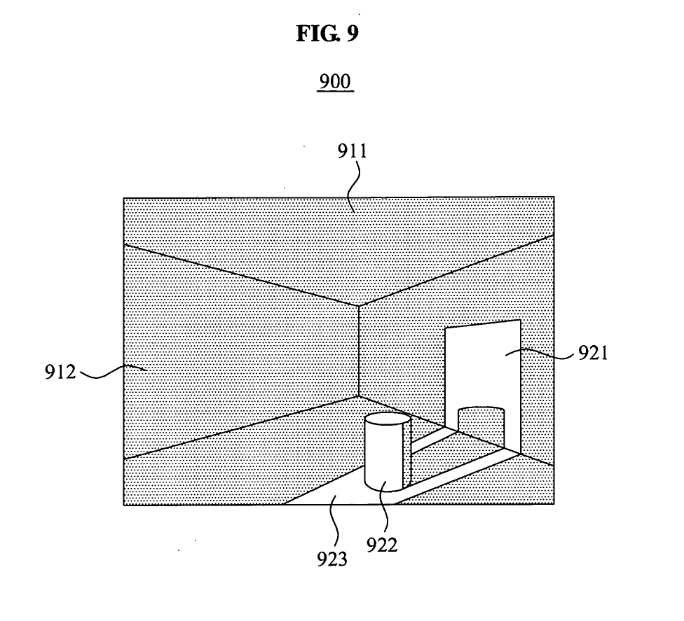

The rendering process and the rendering result will be further described with reference to FIG. 9.

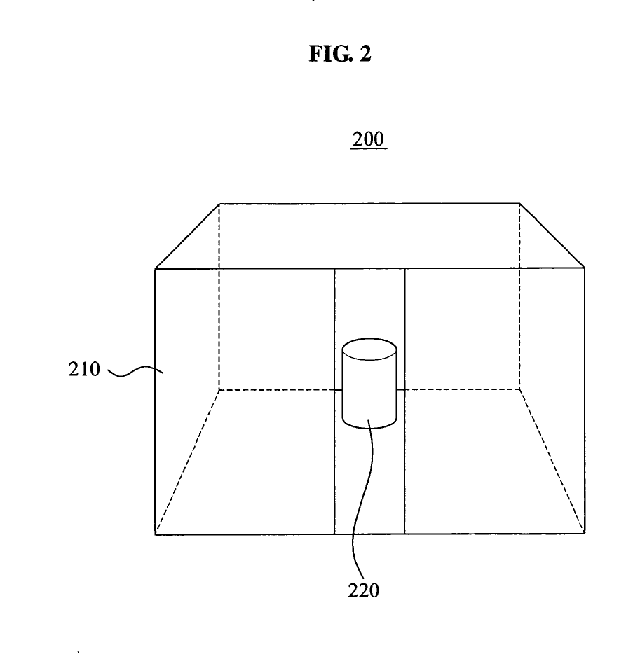

Hereinafter, examples of performing, by the image processing apparatus 100, image processing of a 3D model will be described with reference to FIG. 2 through FIG. 9.

FIG. 2 illustrates a 3D model 200 rendered by an image processing apparatus and method according to example embodiments.

The 3D model 200 may include an object 210 that represents a room with a partially open front, and an object 220 that is provided in a cylindrical form within the room. The 3D model 200 is only an example and thus, a variety of examples may be applicable.

The 3D model 200 of FIG. 2 is observed at a light view of the 3D model 200. Hereinafter, it may be assumed that another independent illumination does not exist within the object 210.

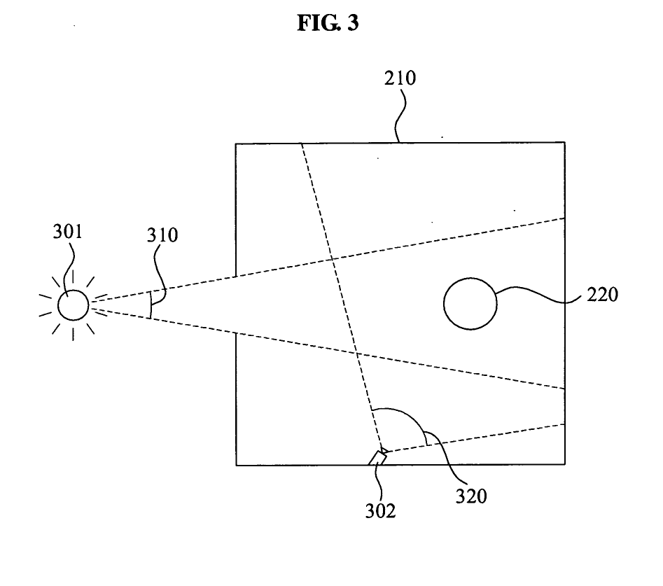

A plan view of the 3D model 200 and a camera view to render an image will be further described with reference to FIG. 3.

FIG. 3 illustrates the objects 210 and 220, and a light source 301 of the 3D model 200 of FIG. 2.

The light source 301 to be used for rendering of the 3D model 200 is located outside the object 210 in a form of a hexahedral room to provide light to inside of the object 210 via a gap of the partially open front of the object 210.

A range of the light of the light source 301 located outside the object 210 that reaches the inside of the object 210 may be expressed by an angle 310. The direct light may not reach an area outside the angle 310 within the object 210.

An area observed at a camera view 302 for image rendering may be expressed using an angle 320. Hereinafter, a process of sampling VPLs and surface points and rendering an image of an area within the angle 320 will be described.

FIG. 4 illustrates potential VPLs adaptively sampled at the light view 301 of FIG. 3.

A radiosity scheme corresponds to one of 3D rendering schemes, and may provide, on a 3D model, VPLs representing a natural phenomenon such as a light reflection, and may render an image based on a change in a color value of an object occurring due to the VPLs.

Generally, according to an increase in a number of VPLs, the rendering quality may be further enhanced. However, since an amount of calculations for shadow map generation and the like significantly increases, a rendering rate may decrease. Accordingly, the VPL sampling unit 110 may densely sample potential VPLs in an area receiving a relatively large amount of light from the light source 301 and reflecting a relatively large amount of light to another area within the 3D model 200, and may sparsely sample the potential VPLs in an area not giving a great effect.

In an example of FIG. 4, based on the light view 301, the VPL sampling unit 110 may densely sample potential VPLs in an area 410 that is relatively close to the light view 301 and/or having a relatively bright object color and/or a relatively great bidirectional reflectance.

The VPL sampling unit 110 may sparsely sample potential VPLs in an area 420 that is further from the light view 301 and/or having a relatively dark object color and/or a relatively low bidirectional reflectance.

The above sampled potential VPLs may include a potential VPL 402 that is provided within the object 210 and does not affect an image observed at the camera view 302. The potential VPL 402 may be differently treated from a potential VPL 401 that is provided within the object 210 and affects the image observed at the camera view 302.

Even though the shadow map is generated with respect to the potential VPL 402, a visible area in an image observed at the camera view 302 may not be affected and thus, the above potential VPL 402 may cause a waste of calculation.

Accordingly, there is a desire for a process of selecting a potential VPL affecting the actual image rendering may be required.

FIG. 5 illustrates a surface point adaptively sampled at the camera view 302 of FIG. 3.

As described above, in a mesh-based 3D model, when rendering of a radiosity scheme is performed by performing a shadow test and the like using a shadow map of VPLs, surface sampling may be used with respect to a portion of meshes.

The point sampling unit 120 of the image processing apparatus 100 may perform the above functionality.

Sampled surface points may be used for a shadow test with respect to a light source or each of VPLs, for example, shadow generation. As a shadowing portion becomes closer to the camera view 302 desired to be rendered or a view sample rendered at the camera view 302, a more accurate expression may be used. Accordingly, relatively dense point sampling may be performed in the shadowing portion.

The point sampling unit 120 may adaptively sample meshes of the 3D model based on a rendering result, instead of uniformly or randomly sampling the meshes of the 3D model.

For example, the point sampling unit 120 may densely sample surface points 511 in an area 510 of meshes relatively close to the camera view 302, and may sparsely sample surface points 521 in an area 520 of meshes relatively further from the camera view 302.

When a distance according to spatial coordinates between each mesh and a camera view is directly calculated for the above process, an amount of calculations may increase.

Accordingly, together with the aforementioned example embodiment or instead of the aforementioned example embodiment, the point sampling unit 120 may densely sample surface points in an area relatively close to a view point sample corresponding to a portion of pixels of the image rendered at the camera view 302, and may sparsely sample surface points in an area relatively further from the view point sample.

Accordingly, even though not particularly described, an adaptive surface point sampling process may not be limited.

FIG. 6 illustrates an operation of the influence calculator 130 according to example embodiments.

An influence W(x) with respect to a surface point x2 of a potential VPL x1 may be calculated according to Equation 1:

$$W ( x ) = \frac{max ( 0 , ( \vec{{n}_{x 1}} \cdot \vec{( {x}_{1} - {x}_{2} )} ) \times max ( 0 , ( \vec{{n}_{x 2}} \cdot \vec{( {x}_{2} - {x}_{1} )} )}{{‖ {x}_{1} - {x}_{2} ‖}^{K}} \qquad [ Equation 1 ]$$

In Equation 1, \vec{nₓ₁} corresponds to a normal vector in the potential VPL x1, \vec{nₓ₂} corresponds to a normal vector in the surface point x2, and K corresponds to a constant adjusting the affect of a denominator term.

The light may be transferred from the light source 301 to the potential VPL x1 along a path 601, and may be transferred to the surface point x2 along a path 602, and then may be transferred to the camera view 302 via a path 603. Through the above process, a transmission probability and a visibility of light, and the like may be reflected to the influence W(x).

When the influence calculator 130 calculates the influence W(x) with respect to surface points with respect to a total of potential VPLs, the VPL selector 140 may select, as final VPLs to be used for rendering, potential VPLs having relatively great influence.

The VPL selector 140 may sample additional VPLs around the selected VPLs by using the selected VPLs as seeds. The above example is to further increase the rendering quality by performing super sampling with respect to VPLs around VPLs that are determined to further affect the rendering.

FIG. 7 illustrates VPLs selected from potential VPLs of FIG. 4 according to example embodiments.

For ease description, potential VPLs of areas 701 and 702 invisible at the camera view 302 are not shown in FIG. 7.

The selected potential VPLs are shown as final VPLs within an object of FIG. 7. As described above, additional VPLs may be generated through super sampling by using the selected potential VPLs as seeds.

FIG. 8 illustrates the selected VPLs of FIG. 7 observed at the camera view 302.

When the VPLs to be used for rendering are determined, the rendering unit 150 of the image processing apparatus 100 may render the image of the camera view 302 using the determined VPLs according to a radiosity scheme.

FIG. 9 illustrates a result 900 of rendering the 3D model 200 of FIG. 2 at the camera view 302 of FIG. 3 based on the VPLs of FIG. 8 according to example embodiments.

Even in areas 911, 912, and the like that are areas not receiving direct illumination among walls within the object 210 in the hexahedral room, a color value may be rendered. A soft shadow may be expressed in boundaries between the above areas 911 and 912, and areas 921, 922, and 923 receiving the direct illumination.

According to example embodiments, arrangement of VPLs and surface point sampling may be adaptively performed and thus, an amount of calculations affecting the rendering may be concentrated. Accordingly, it is possible to enhance a total calculation rate and the rendering quality compared to calculation resources.

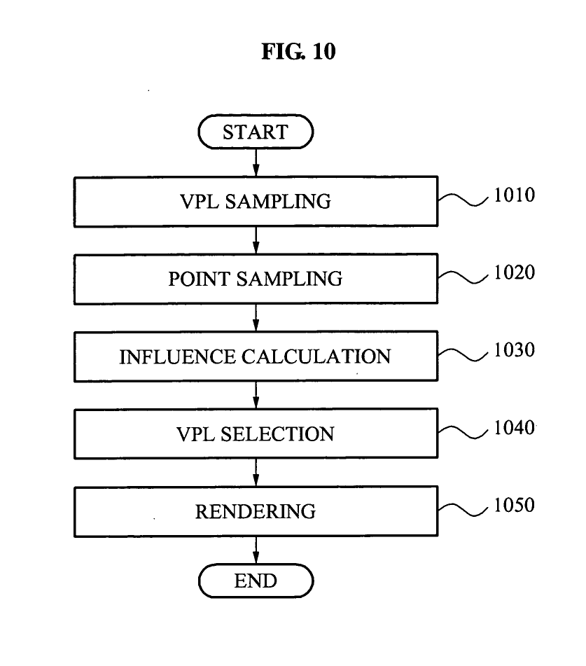

FIG. 10 illustrates an image processing method according to example embodiments.

In operation 1010, the VPL sampling unit 110 may sample a plurality of potential VPLs within a 3D model based on an object characteristic and a position of a real light view within the 3D model.

The VPL sampling unit 110 may sample the potential VPLs in a visible area at a light view within the 3D model.

In this example, as a distance from the light view becomes shorter, as a bidirectional reflectance increases, and as an object surface color becomes brighter, the potential VPLs may be further densely sampled.

Adaptive sampling of potential VPLs is described above with reference to FIG. 4 and thus, further descriptions will be omitted here.

In operation 1020, the point sampling unit 120 may sample a plurality of surface points representing geometry information of a mesh based 3D model within the 3D model.

3D rendering of a radiosity scheme using generation of a shadow map and a shadow test may sample and process geometry information of an object based on a point.

In this example, the point sampling unit 120 may adaptively sample surface points to be used for rendering.

Adaptive sampling of the surface points indicate dense sampling of surface points on an area substantially affecting the rendering quality and parse sampling of surface points on an area not affecting the rendering quality.

A variety of examples of the point sampling unit 120 performing the surface point sampling are described with reference to FIG. 5 and the like.

In operation 1030, the influence calculator 130 may calculate an influence with respect to surface points sampled by the point sampling unit 120, with respect to each of potential VPLs.

The influence calculation is described above with reference to FIG. 6 and Equation 1.

In operation 1040, the VPL selector 140 may select, as a final VPL to be used for 3D rendering of a radiosity scheme, only a potential VPL having an influence greater than or equal to a predetermined threshold.

In addition to selecting of a portion of the potential VPLs, the VPL selector 140 may sample additional VPLs around a selected VPL by using the selected VPL as a seed. The above process may be referred to as super sampling of additional VPLs.

The VPL selection process and result is described above with reference to FIG. 7 and FIG. 8.

In operation 1050, the rendering unit 150 may sample the 3D model using selected VPLs according to a global illumination based radiosity scheme and the like. The 3D model sampling process is described above with reference to FIG. 9.

The image processing method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. An image processing apparatus, comprising:
a virtual point light (VPL) sampling unit to sample a plurality of potential VPLs by rendering a three-dimensional (3D) model at a light view;
an influence calculator to calculate an influence with respect to at least one surface point sampled at a camera view, with respect to each of the potential VPLs; and
a VPL selector to select at least one VPL from the plurality of potential VPLs based on the calculated influence.

2. The image processing apparatus of claim 1, wherein the VPL sampling unit adaptively samples the plurality of potential VPLs based on at least one of a distance from the light view, a bidirectional reflectance of an object point, a color of the object point, and combinations thereof.

3. The image processing apparatus of claim 1, wherein the VPL sampling unit adaptively samples the plurality of potential VPLs based on a color value obtained by rendering the 3D model at the light view.

4. The image processing apparatus of claim 1, further comprising:
a point sampling unit to sample at least one surface point from geometry information of the 3D model at the camera view,
wherein the point sampling unit adaptively samples the at least one surface point based on at least one of a distance from the camera view, a bidirectional reflectance of an object point, a color of the object point, and combinations thereof.

5. The image processing apparatus of claim 1, further comprising:
a rendering unit to generate a shadow map with respect to each of the at least one VPL, and to render an image of the 3D model observed at the camera view, using a radiosity scheme.

6. The image processing apparatus of claim 1, wherein the influence is calculated based on at least one of a distance between each of the potential VPLs and the at least one surface point, and an inner product of a normal vector.

7. The image processing apparatus of claim 1, wherein the VPL selector selects the at least one VPL from the plurality of potential VPLs by calculating a cumulative distribution function (CDF) of a distribution curve of the influence with respect to each of the potential VPLs, and by randomly selecting a CDF value.

8. The image processing apparatus of claim 1, wherein the VPL selector determines at least one additional VPL around the selected at least one VPL.

9. An image processing apparatus, comprising:
a point sampling unit to sample at least one surface point from geometry information of a 3D model at a camera view;
an influence calculator to calculate an influence with respect to each of at least one surface point, with respect to each of at least one visible point that is visible at a light view, among the at least one surface point; and
a VPL selector to select at least one VPL from the at least one visible point based on the calculated influence.

10. The image processing apparatus of claim 9, wherein the point sampling unit adaptively samples the at least one surface point based on at least one of a distance from the camera view, a bidirectional reflectance of an object point, a color of the object point, and combinations thereof.

11. The image processing apparatus of claim 9, wherein the influence is calculated based on at least one of a distance between each of the at least one visible point and the at least one surface point, and an inner product of a normal vector.

12. The image processing apparatus of claim 9, wherein the VPL selector selects the at least one VPL from the at least one visible point by calculating a cumulative distribution function (CDF) of a distribution curve of the influence with respect to each of the at least one surface point, and by randomly selecting a CDF value.

13. The image processing apparatus of claim 9, wherein the point sampling unit densely samples the at least one surface point in an area substantially affecting a rendering quality.

14. An image processing method, comprising:
sampling a plurality of potential virtual point lights (VPLs) by rendering a three-dimensional (3D) model at a light view;
calculating an influence with respect to at least one surface point sampled at a camera view with respect to each of the potential VPLs; and
selecting at least one VPL from the plurality of potential VPLs based on the calculated influence.

15. The image processing method of claim 14, wherein the sampling comprises adaptively sampling the plurality of potential VPLs based on at least one of a distance from the light view, a bidirectional reflectance of an object point, a color of the object point, and combinations thereof.

16. The image processing method of claim 14, wherein the sampling comprises adaptively sampling the plurality of potential VPLs based on a color value obtained by rendering the 3D model at the light view.

17. The image processing method of claim 14, further comprising:
sampling at least one surface point from geometry information of the 3D model at the camera view,
wherein the sampling of the at least one surface point comprises adaptively sampling the at least one surface point based on at least one of a distance from the camera view, a bidirectional reflectance of an object point, and a color of the object point.

18. The image processing method of claim 14, further comprising:
generating a shadow map with respect to each of the at least one VPL, and rendering an image of the 3D model observed from the camera view using a radiosity scheme.

19. The image processing method of claim 14, wherein the influence is calculated based on at least one of a distance between each of the potential VPLs and the at least one surface point, and an inner product of a normal vector.

20. The image processing method of claim 13, wherein the sampling further samples additional VPLS around a selected VPLS using the selected VPL as a seed.

21. A non-transitory computer-readable medium comprising a program for instructing a computer to perform the method of claim 14.
